(19) United States
(12) Patent Application Publication
(10) Pub. No.: US 2008/0235148 A1
(43) Pub. Date: Sep. 25, 2008

(54) Online Dynamic Evaluation and Search for Products and Services

(76) Inventor: Jiezhou Liu, Sunnyvale, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 12/052,704

(22) Filed: Mar. 20, 2008

Related U.S. Application Data
(60) Provisional application No. 60/895,949, filed on Mar. 20, 2007.

(51) Int. Cl. G06Q 30/00; G06Q 99/00; G06F 17/30; G06F 15/16; H04L 9/32; G06F 7/06

(52) U.S. Cl. 705/80; 705/7; 707/5; 707/E17.017

(57) ABSTRACT

In one aspect, computer implemented dynamic evaluation is based on feature tags. As will be described in more detail below, a buyer may be interested in certain features of a product (e.g., color, material, design, lining, warranty, delivery terms, etc.) and the different features are described using feature tags. For custom products, the buyer's specification may be described at least in part by feature tags. Each feature tag may include one or more standardized keywords. The computer-based system can use the feature tag representation of a buyer's order to both search for appropriate products (i.e., appropriate sellers of the product requested by the buyer), and then subsequently to allow the seller to review the performance of the selected buyer. Over time, each seller will receive different reviews from different buyers. These reviews can be stored and the data used to better predict which sellers will be appropriate for a future buyer request. Buyers can also be evaluated and reviewed to allow similar screening by the sellers. The use of standardized keywords establishes a common vocabulary and rating system among the community of buyers and sellers.

### CROSS-REFERENCE TO RELATED APPLICATION(S)

This application claims priority under 35 U.S.C. § 119(e) to U.S. Provisional Patent Application Ser. No. 60/895,949, “Online Dynamic Evaluation And Search For Products And Services,” filed Mar. 20, 2007.

### BACKGROUND OF THE INVENTION

1. Field of the Invention

This invention relates to online dynamic evaluation and/or search for products and services and their respective buyers and sellers. It especially relates to products and services that are customizable.

2. Description of the Related Art

One problem in current Internet marketplaces and e-commerce systems is that online searches and evaluation of the quality of products and services (which depends on the capabilities of the underlying manufacturer) are conducted using “generic” criteria that are applied to all potential buyers and sellers. As such, it is difficult for a buyer to search for and/or evaluate products and services using criteria that are important to the buyer—for example, custom products that match the buyer's specific requirements. It can also be difficult for new products and services, especially those from small companies, to enter the market since the quality of these products and services (and their sources) is difficult to evaluate due to their lack of history.

These problems are exacerbated in the case of custom products and services since each buyer has their own unique set of requirements and quality level for products and services. The buyers and sellers must rely either on third parties or on legal obligations in agreements. However, if a buyer and a seller are located in different countries, as is frequently the case for international business, reliance on legal agreements is more difficult since the buyer and seller may come from completely different legal systems, cultures, and languages. In these cases, search engines based on generic criteria will return many different products/services without the information, which is relevant to the buyer. As a result, it is extremely difficult for a buyer to evaluate which product/service (or, which source of product/service) is the most appropriate for the buyer's requirements. The buyer's only recourse is to contact a larger number of potential sellers, many of whom may be entirely inappropriate. At the same time, sellers may receive many unqualified inquiries, thus making it more difficult to determine which inquiries to respond to and do business with.

Due to the aforementioned drawbacks, current approaches for online search do not adequately address certain segments of buyers and sellers. As such, there is a need for a system to more adequately evaluate and rate the quality of products and services (where “quality” is to be interpreted broadly).

### SUMMARY OF THE INVENTION

The present invention relates to computer implemented methods and systems for dynamic evaluation and search for products and services, especially custom products and services. Many Internet marketplaces, e-commerce systems, and search engines have software components such as search, catalog, order, ratings and comments, etc. Dynamic evaluation and search as described herein is typically implemented as part of the search and/or order functions.

In one aspect, computer implemented dynamic evaluation is based on feature tags. As will be described in more detail below, a buyer may be interested in certain features of a product (e.g., color, material, warranty, delivery terms, etc.) and the different features are described using feature tags. For custom products, the buyer's specification may be described at least in part by feature tags. Each feature tag may include one or more standardized keywords. The computer-based system can use the feature tag representation of a buyer's order to both search for appropriate products (i.e., appropriate sellers of the product requested by the buyer), and then subsequently to allow the seller to review the performance of the selected buyer. Over time, each seller will receive different reviews from different buyers. These reviews can be stored and the data used to better predict which sellers will be appropriate for a future buyer's request. Similarly, buyers can also be evaluated and reviewed to allow similar screening by the sellers. The use of standardized keywords establishes a common vocabulary and rating system among the community of buyers and sellers.

In one implementation, the buyers and sellers interact via a distributed network (e.g., via forms on an Internet web site that implements the dynamic evaluation and/or search functionality). This approach can be particularly useful in enhancing the performance of search engine results in the search for product and service information in hypermedia data storage elements such as websites in the World Wide Web. In one implementation, the search engine query string is a plurality of feature tags followed by their requested quality ratings (or range of ratings). The search engine result is a plurality of feature tags followed by the evaluations of sellers.

Accordingly, several objects and advantages of the present invention include some or all of the following: (a) To improve search engine performance for the evaluation of products and services (and their sources), especially custom products and services, for international business. For example, evaluation based upon past reviews of products and services (or their sources). (b) To enable buyers to evaluate products and services (and their sources) more clearly and effectively. To enable buyers to specify the features of products and services and the quality rating for those features that a buyer is interested in. (c) To enhance the efficiency and integrity of business between buyers and sellers, especially for international business. (d) To support improved customization, personalization, and creativity for products and services. (e) To facilitate communication and ease of business between potential buyers and sellers.

Additional aspects, applications and advantages will become apparent in view of the following description and associated figures.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a diagram of various systems used in one implementation of the invention.

FIG. 2a is a flowchart of an example order review process in a client system of a buyer.

FIG. 2b is a flowchart of an example order review process in a client system of a seller.

FIG. 3 is a flowchart of an example order review process in a server.

FIG. 4 is an example form for entering requested quality ratings during an order evaluation process in a web browser.

FIG. 5a is a flowchart of an example negotiation process in a client system of a buyer.

FIG. 5b is a flowchart of an example negotiation process in a client system of a seller.

FIG. 6 is a flowchart of an example negotiation process in a server.

FIG. 7 illustrates a display of product information during an order negotiation process in a web browser.

FIG. 8 illustrates a display of due date information during an order negotiation process in a web browser.

FIG. 9 illustrates a display of warranty information during an order negotiation process in a web browser.

FIG. 10 illustrates a display of payment information during an order negotiation process in a web browser.

FIG. 11 illustrates a display of cost information during an order negotiation process in a web browser.

FIG. 12 illustrates a display of summary information during an order negotiation process in a web browser.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

The seller is generally the entity that sells the products/services, typically on behalf of manufacturers. Example sellers include manufacturers, exporters, suppliers, etc.

The buyer is generally the entity that buys products/services directly from the seller as above. Example buyers include importers, wholesalers, etc.

Custom products/services are generally products/services that are made (or tailored, modified) according to the specifications of the buyers. For example, to order baseball caps, an importer might provide a specification that defines the color, material, design of hat front, hat body, hat logo, hat label, etc. to the selected manufacturer. The manufacturer produces the baseball caps according to the specification.

Aspects of the invention apply to any products and services that are made according to specifications, not only custom products. For example, a manufacturer may have recently designed a new style of the baseball caps. The importers and wholesalers search before purchasing and evaluate after purchasing the baseball caps based on the specification provided by the seller.

Order information includes information used to specify an order, typically identification of products/services, packaging, warranties, shipping, payment, cost, etc. The order information can also include order quality information (as described below). In some implementations, the finalized order information (i.e., as agreed between the buyer and seller) forms a digital order agreement between the seller and the buyer. The order information can be presented using may different digital formats, such as text, images, video or other media files.

Order information can be expressed in part as a set of feature tags (also called manufacturing feature tags), which can be evaluated by computer. Order quality information can also be defined as a set of manufacturing feature tags for an order and their corresponding quality ratings. Each feature tag is corresponding one or more manufacturing processes. Producing a product generally involves many manufacturing processes. For example, producing a baseball cap involves design, material fabrication, coloring, lining, quality control, packaging, shipment, and other related processes. In one embodiment, some or all of the manufacturing processes have corresponding manufacturing features and manufacturing feature tags. Buyers can use these feature tags to describe the products they need and rank sellers.

In one approach, an overall order is evaluated by evaluating each of the feature tags and quality ratings within the order (as will be described in greater detail below). Feature tags can be built up from standardized keywords. For example, the final order information for a baseball cap might specify the color as “light blue color, pantone color 1234-534, High Quality.” In this example, “light blue color”, “blue color” and “color” are different feature tags that describe the color feature being evaluated; and “light”, “blue”, and “color” are keywords that make up these feature tags. Assume that, in this example, “color” is the feature tag used to evaluate potential products. “pantone color 1234-534” is the specific feature desired. “High Quality” is the quality rating for the feature tag, which preferably is also standardized. “light blue color, pantone color 1234-534, High Quality” is part of the order information. “color, High Quality” is the requested order quality information of the feature tag and its rating. This can be used to evaluate the quality of a potential supplier's color department or coloring process.

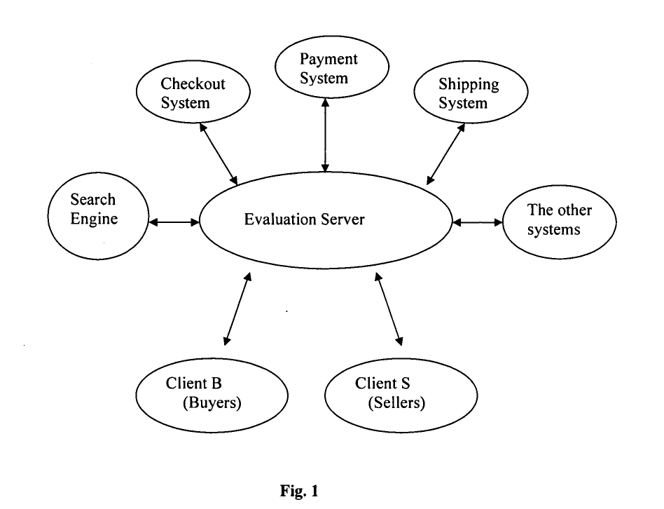

FIG. 1 shows a diagram of various systems used in one implementation of the invention. The evaluation server (which will sometimes be referred to simply as the server) implements the dynamic evaluation. It interfaces with the various client systems (the client), and possibly also separate search engine, checkout system, payment system, shipping system, and other systems.

The server uses the clients to communicate with buyers and sellers. The clients are systems that buyers and sellers use to view, enter and/or edit the order information, send and receive the order information to the server, and maybe sign or encrypt the order information. Assume client B is a client software system used by the buyer and client S is a client software system used by the seller. The clients can be software systems downloaded from the server such as web pages with HTML, javascript, activeX controls, etc. It also can be software systems installed in the computers or other devices of the buyer or the seller. It even can be implemented as a distributed system such as an entire email system, etc. The client B and client S typically have at least a visual user interface (although not required if the buyer or seller interface is automated), processing logic, and communication interface with the indicated systems of the buyer and the seller. The server also has access to past reviews of sellers and buyers.

Search engines can request evaluations (or other related information) of a seller or a product/service from the server, for example to respond to a buyer's search or to improve search engine performance.

Checkout system manages orders, payment and shipping.

A payment system may offer multiple payment methods for buyers and sellers to select from. Similarly, the shipping system can offer multiple shipping methods for buyers and sellers to select from. The payment system and shipping system can be features of the buyer's order, which will be evaluated by the server.

Other systems include any other systems that may interact with the evaluation service. Examples include Internet marketplaces, e-commerce systems, etc. For example, an e-commerce website of a manufacturer might request an order evaluation from the server.

In the aforementioned example, the clients, the server, the checkout system, the payment system, the shipping system, the search engine and the other systems are all connected to one another via a computer based distributed network such as the Internet.

The server can be an independent service provider or part of an Internet market, an e-commerce system, or a search engine. Internet marketplaces, e-commerce systems and search engines usually have software components such as search, catalog, order, evaluations, etc. The server typically implements a significant part of the search component and the order component.

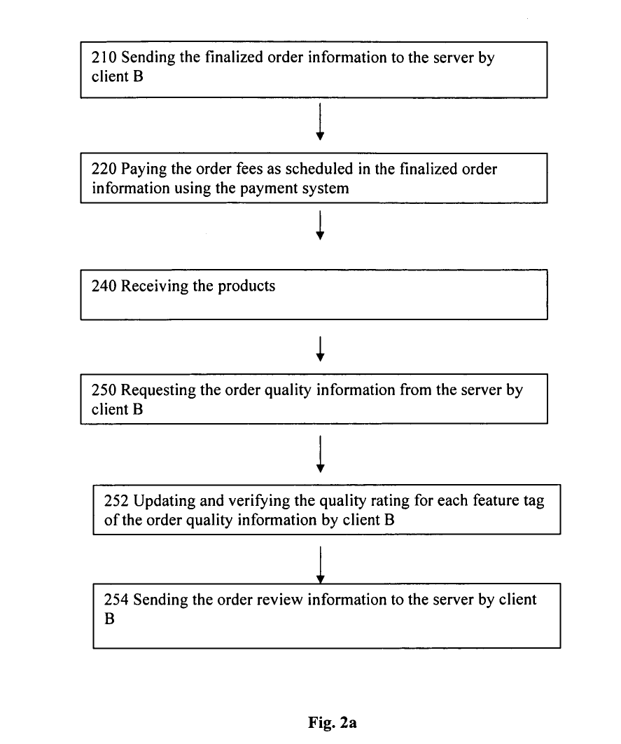

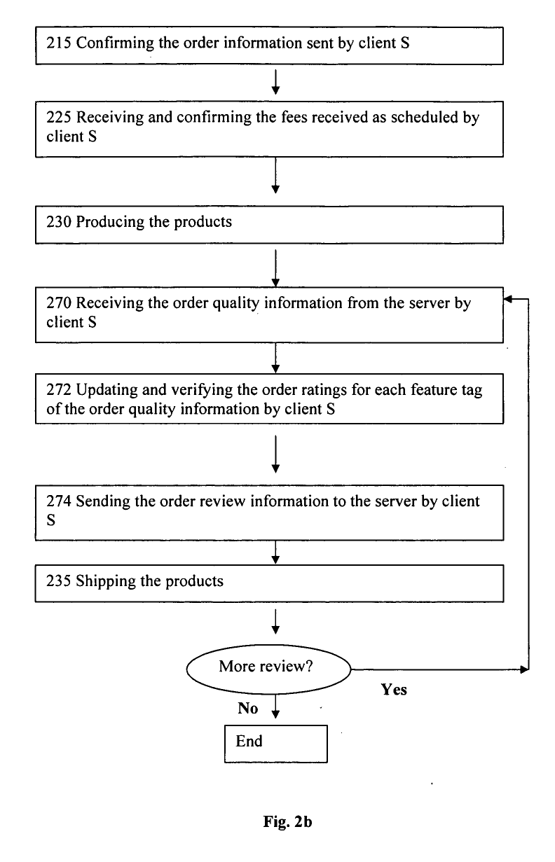

When initiating an order, the buyer begins by searching for a product and its seller that closely matches the buyer's needs. Then, the buyer negotiates with the seller to finalize the order. Once the order is finalized, the buyer and seller can review each other, as shown in FIGS. 2a and 2b.

FIG. 2a shows a flowchart of an example order review process in a client system of a buyer.

FIG. 2b shows a flowchart of an example order review process in a client system of a seller.

Using FIGS. 2a and 2b, this is an example of how an order would process through a buyer's and a seller's systems.

To specify the quality of the order and for ease of the communication, the buyer can send the finalized order information, an order agreement, to the server by client B (210). The seller confirms the order information by client S (215).

After the finalized order information, the buyer pays the seller using the payment system (220). The server may also get the payment information from the payment system to assist the evaluation of payment (225).

Next the seller produces the product (230), then the seller goes through a self evaluation of the product.

After having received the initial order quality information from the server (270), the seller records its review by updating the quality ratings for the feature tags by client S (272). The seller sends the updated and verified order quality information (which shall be referred to as the order review information) to the server by client S (274).

After the review (although not necessarily after), the seller ships the product using one of the shipping systems (235). The server may also get the shipping information from the shipping systems to assist the review of shipping. Alternatively, the seller may choose to perform the quality review (270 to 274) after shipping.

Referring to FIG. 2a (the buyer's process), after having received the ordered products (240), the buyer requests the order quality information from the server (250). The buyer evaluates the order by updating quality ratings for the feature tags using client B (252). The buyer sends its order review information to the server by client B (254).

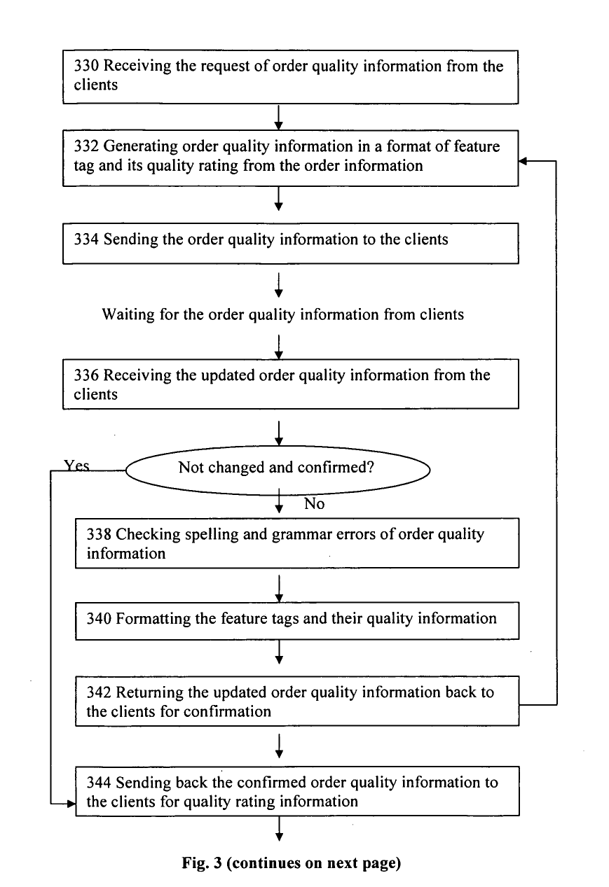

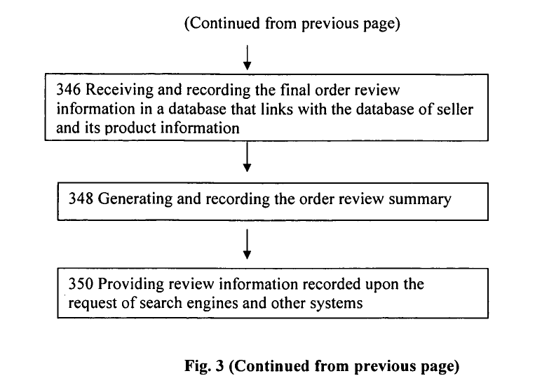

FIG. 3 shows a flowchart of an example order review process in the server.

After receiving the finalized order information from client B (the buyer) and confirmed by client S (the seller), the server generates order quality information from the order information as follows.

The server receives requests for order quality information from the clients of the buyer and the seller (330):
The server repeats the following steps:
   generating order quality information in a format of feature tag and its quality information from the finalized order information (332).
   sending the order quality information to the clients (334).
   receiving the updated order quality information from the clients (336).
   checking spelling and grammar errors of order quality information (338).
   formatting feature tags and their quality information (340).
   returning the updated order quality information back to the clients for confirmation (342).
sending back the confirmed order quality information to the clients for quality rating information (344).
receiving and recording the final order review information in a data storage element (e.g., a database) that links with a data storage element (e.g., a database) of seller and its product information (346).
generating and recording an order review summary (348).
providing the recorded review information upon the request of search engines and other systems (350).

Feature tags can be generated by the following methods:
The feature tags are provided by the seller when providing initial product and its order information
The feature tags are provided by the buyer or the seller during order negotiation between the buyer and the seller.
The system automatically generates the feature tags.
Combinations of the above methods

Methods to generate keywords from documents can also be used to generate feature tags from order information by treating order information as a document. For example, see U.S. Pat. Nos. 6,470,307; 6,240,378; 6,173,251; and 7,055,094, which are incorporated herein by reference.

The server provides the order quality information to the clients on the request for an order quality review from the client of the buyer or the seller (334). The order quality information can include, but is not limited to, the ratings for feature tags and/or comments for feature tags.

For example, the quality ratings to feature tags can be categorized by
Best/High End
Extra/Better/Middle
Pass/Low End
Discounted
Returned/Not Passed/Unqualified

The quality ratings of feature tags can also be implemented numerically. For example, the quality rating can be based on a 1-10 scale, or it can be based on a 0-100% scale. Other rating scales can also be used.

An example of the data format for the order quality information and review information of a feature tag looks like the following. The comments are optional.

### Feature tag

Quality rating for the feature tag Comments for the feature tag

The server records the revised order quality and its review information in a data storage element such as database and file systems (346) in a format such as XML. A review summary can also be generated, such as the overall review of the order for all feature tags, the aggregate or average review of each feature tag over a number of orders, the overall rating of a seller or buyer over a number of orders, suggested payment, etc. (348).

The overall review or rating of an order can be calculated based on the ratings of all of the feature tags in the order. Examples include calculating the sum of the ratings of all of the feature tags of the order, and calculating averages based on ratings of all of the feature tags in the order.

The overall rating of a feature tag for a seller can be calculated based on the ratings of that feature tag for all orders by that seller. Examples include calculating the sum of the ratings for that feature tag across all orders for that seller, calculating the average of the ratings for that feature tag, and determining how many orders have a rating that is above a certain threshold. The feature-tag specific rating gives an indication of a seller's capability with respect to that feature. For example, if a seller has an average rating of High Quality for feature tag color, that indicates the seller's coloring department/process/facility is high quality.

The overall rating of a seller can be calculated based on the ratings for all feature tags and all orders for the seller.

Similar ratings can be calculated for buyers.

The buyer and the seller can negotiate the actual fees of the order based on the order review summary.

The above order review information of feature tags, products and services, etc. can be used to improve the performance of search engines, and to provide order review information to other systems.

When selecting a product (or source for a product) from an Internet marketplace, an e-commerce system or the other systems that integrate and use the server, the buyer sends a query string to a search engine to search for a seller to match his requirements of products and services. In one implementation, the query string will be in a format circulating Feature Tag Feature Tag Requested Quality Rating, like the following:

Feature tag 1, Feature tag 1 requested quality rating; Feature tag 2, Feature tag 2 requested quality rating; . . . .

The search engine receives the query string and searches the data storage element of feature tags and order review information from the server to best match the query string. Since the data storage element is linked with seller information, the search results return feature tags and their evaluations (e.g. ratings or rankings) as well as seller information. The ranking of products and sellers depend on query evaluation requirements set by the buyer (e.g., relative weighting of the different feature tags).

For example, for a specific feature tag, the buyer might specify requested quality rating as one of the following.
Best/High End
Extra/Better/Middle
Pass/Low End
Discounted
Returned/Not Passed/Unqualified

Or the buyer might specify the requested quality rating as a percentage, or as a numerical rating.

If no quality rating is specified by the buyer for a feature tag, then products and sellers can be ranked according to their rating relative to each other (as opposed to how well they match the buyer's requested rating).

Due to the complexity of the above order negotiation and evaluation process, user friendliness is very important to the software design and implementation.

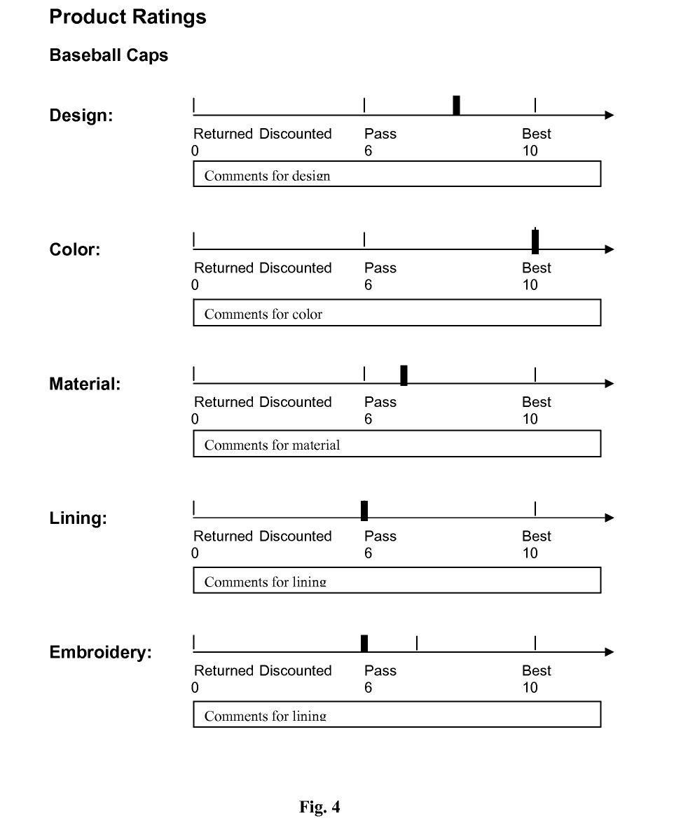

FIG. 4 shows a form for entering requested quality ratings during an order evaluation process in a web browser.

This user interface is written in AJAX, web services and web technologies that have significantly improved the users' experience. It uses XML files to store order quality information. Every line of feature tags is followed by a line of quality rating to the feature tag and a line of possible comments for the feature tag.

Email clients such as Microsoft Outlook can also be clients for the server.

In this case, the email content can be formatted as required by the server. For example, XML style tags in email content can be used to specify feature tags, ratings to feature tags, comments to feature tags, etc.

The following example is a format for a review of an order, although a similar format can be used to request search queries.

```
<review>
  <buyer>buyer</buyer>
  <seller>seller</seller>
  <order_id>1</order_id>
  <product>
    <name>baseball caps</name>
    <feature tag>
      <name>color</name>
      <rating>3</rating>
      <comment>color does not match well</comment>
    </feature tag>
    <feature tag>
      <name>design</name>
      <rating>4</rating>
      <comment>very good</comment>
    </feature tag>
    <feature tag>
      <name>material</name>
      <rating>5</rating>
      <comment>excellent</comment>
    </feature tag>
    ....
</product>
  <packaging>
  ...
  </packaging>
  <duedate>
  ....
  </duedate>
  <warranty>
    ...
  </warranty>
    <payment>
    ...
    </payment>
    <shipping>
    ...
      </shipping>
      <cost>
      ...
      </cost>
      ...
</review>
```

Or it can be simply like the following.

### Review

Buyer: buyer
Seller: seller

### Order ID: 1

Product Name: baseball caps
Feature Tag: color

### Rating: 3

Comment: color does not match well
Feature Tag: design

### Rating: 4

Comment: very good
Feature Tag: material

### Rating: 5

Comment: excellent
Feature Tag: feature
Rating: rating
Comment: comment
. . .

### Packaging Name:

. . .

Optionally, the server can provide service to manage the order negotiation process as in the following example.

Assume the buyer invokes the client B to start to negotiate an order. The buyer requests and receives the general order information from an Internet marketplace or other systems initially provided by the seller. The buyer edits the order information in the client B. The information is then sent to the server. The server returns to the client B the updated order information with the suggested and formatted feature tags for review and confirmation if needed. The buyer then is able to further edit the order information in the client B and send the updated order information back to the server. The server notifies client S of the seller for the updated order information upon the request of the client B of the buyer.

The seller makes changes to the order information by client S. It then sends the information back to the server. The server returns the updated order information with the suggested and formatted feature tags for review and confirmation if needed to the client S. The seller is able to further edit the order information in the client S and send the updated order information back to the server. The server notifies the client B of the buyer for the updated order information upon the request of the seller.

The above process continues until both the buyer and the seller reach a digital order agreement. The digital order agreement can be digitally signed, encrypted and recorded in a persistent data storage element such as database and file system in a format such as XML.

The above negotiation process also can be simplified. For example, the buyer enters, edits and sends the order information to the server by client B. The server notifies the client S upon the request of the client B. Then the seller is only able to select between “accept the order” and “decline the order”. At this case, the feature tags can be part of the order information determined by the buyer, or the server takes full responsibility for generating feature tags for this order in the background.

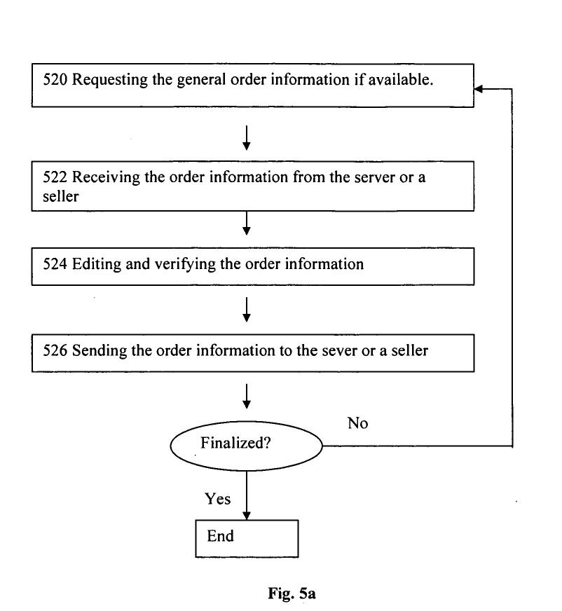

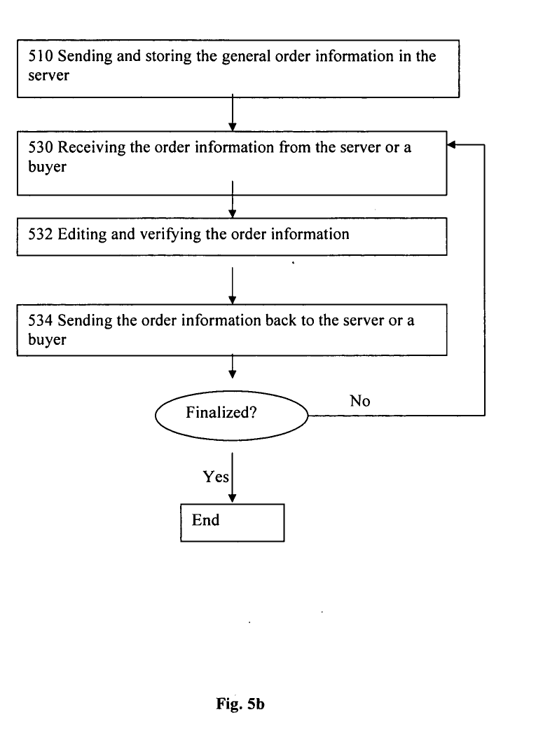

FIG. 5a shows a flowchart of an example negotiation process in a client system of a buyer.

FIG. 5b shows a flowchart of an example negotiation process in a client system of a seller.

The seller initially stores 510 the general order information in the server.

The buyer requests general order information (520), receives the order information from the server or a seller (522) and views the general order information in client B. Then the buyer verifies and edits the general order information (524). Finally the edited order information is sent back to and recorded in the server or by the seller (526). This process continues until the order information is finalized.

Upon receiving the order negotiation information (530), the seller views, edits and formats the order information by client S (532). Eventually the edited order negotiation information is sent to and recorded in the server (534). This process continues until the order information is finalized.

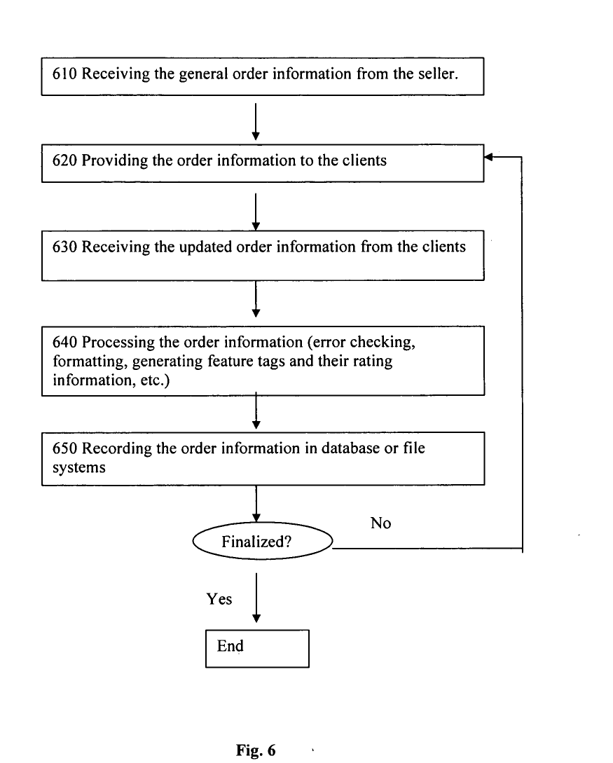

FIG. 6 shows a flowchart of an example negotiation process in a server.

The server has the communication components with the clients and other systems that request the services, the processing logic, and the data storage elements such as database and file system to store the order information in a format such as XML.

The server goes through the following steps.

610: obtaining the general order negotiation information from the seller
620: providing the order information or the general order information to the clients
630: receiving the updated order information from the clients
640: processing the order information, checking errors, formatting and generating feature tags and their rating information, etc.
650: recording the order information in the data storage element such as database and file systems in a format such as XML
repeat: steps 620-650 repeat until the order information is finalized. The finalized order information is the digital order agreement between the buyer and the seller.

Due to the complexity of the above order negotiation process, user friendliness is important to software design and implementation of the invention.

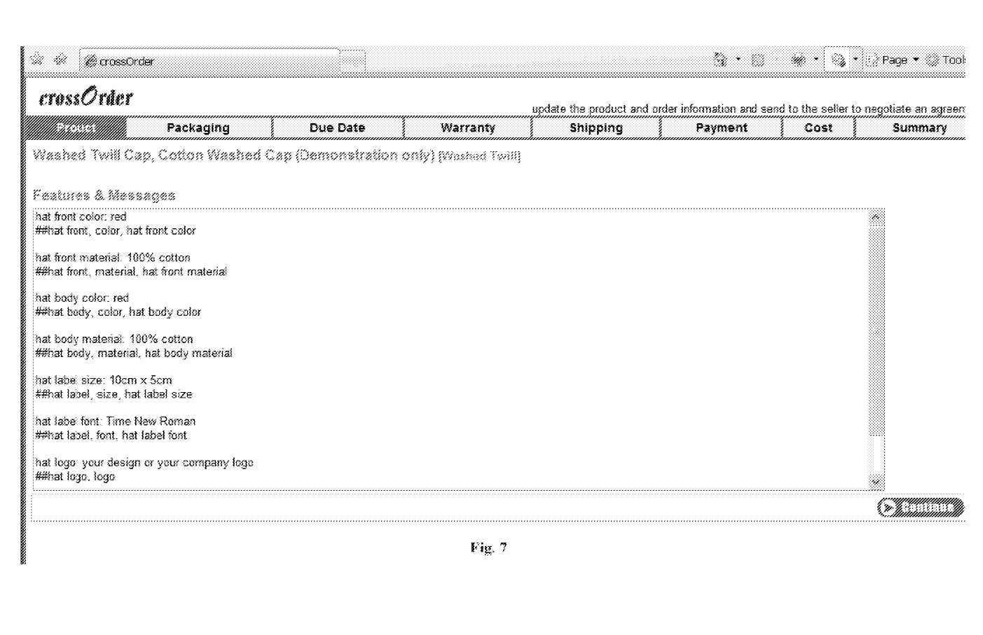

FIGS. 7 to 12 shows some information during an order negotiation process in a web browser. This user interface is written in AJAX, web services, and web technologies that have significantly improved the users' experience. The order information is stored in XML files sent between the clients and the server.

FIG. 7 shows product information during an order negotiation process in a web browser. The product information is formatted such that each feature is followed on the next line by a feature tag. The same rules apply to the packaging information.

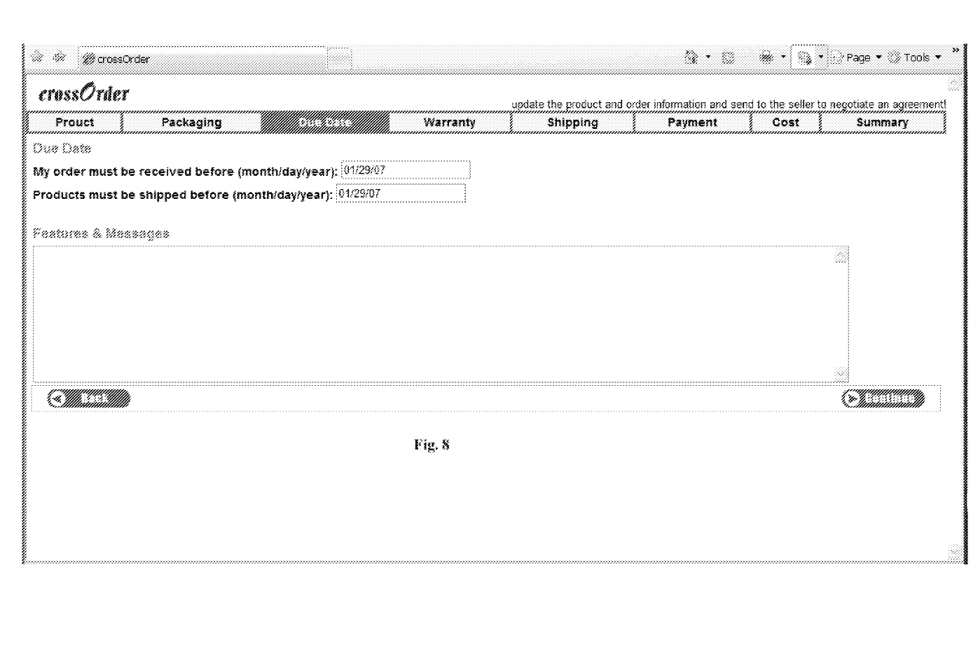

FIG. 8 shows due date information during an order negotiation process in a web browser.

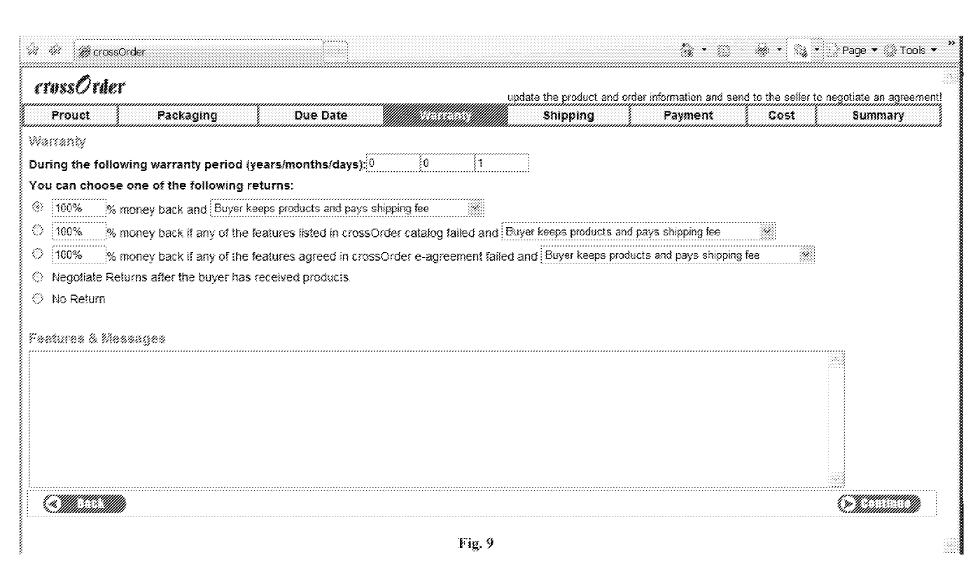

FIG. 9 shows warranty information during a negotiation process in a web browser.

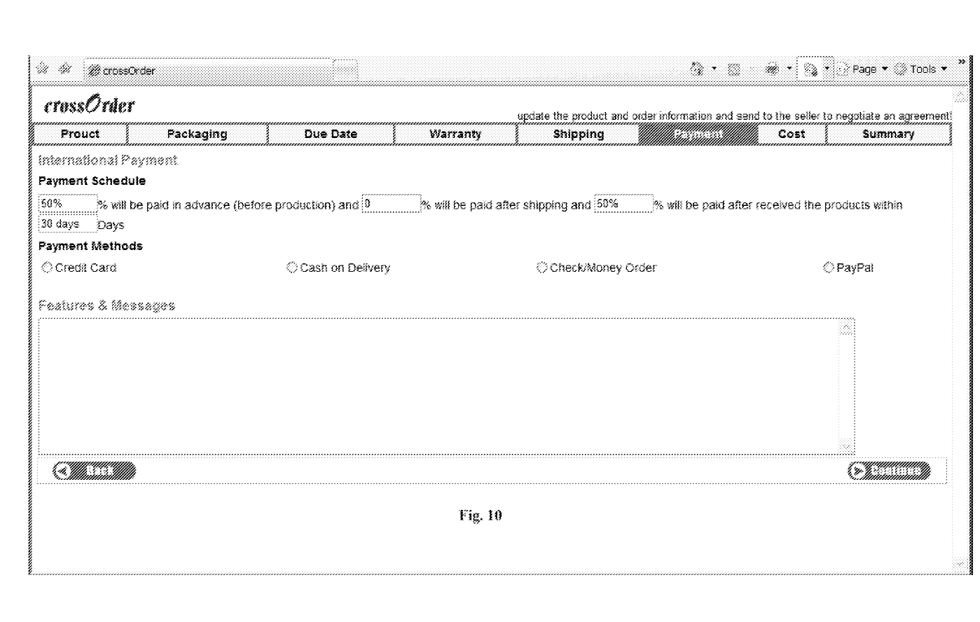

FIG. 10 shows payment information during an order negotiation process in a web browser.

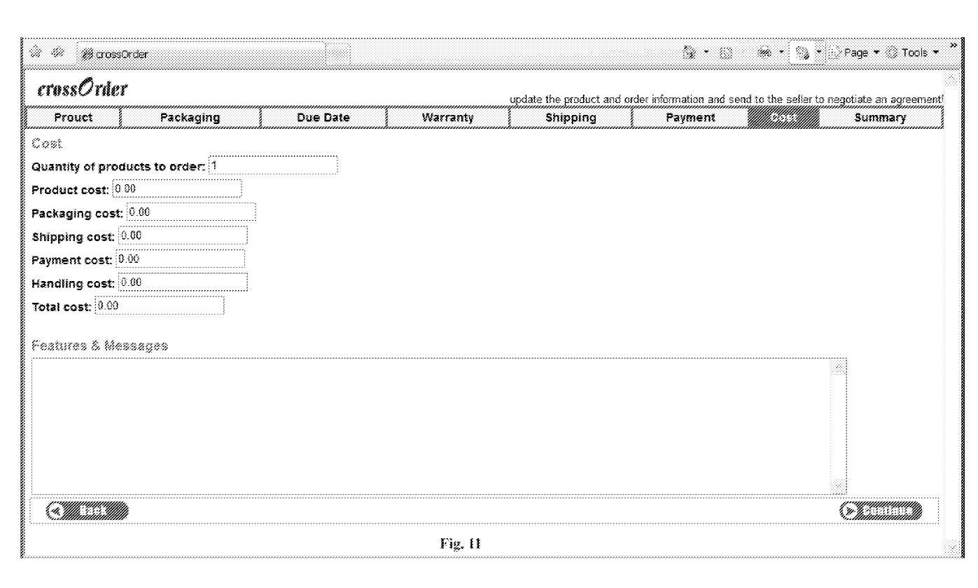

FIG. 11 shows the cost information during an order negotiation process in a web browser.

The above figures show that the server can provide forms and information to assist the order negotiation process. The buyer and the seller are also able to provide additional order feature tags and other order quality information in the text boxes.

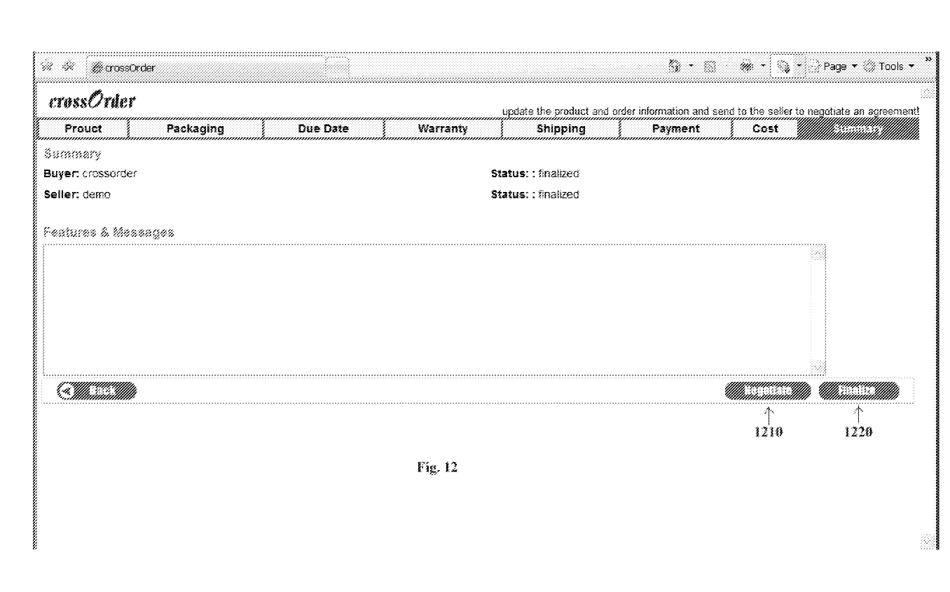

FIG. 12 shows the summary information during an order negotiation process in a web browser.

The buyer and the seller can click the negotiate button (1210) to indicate that the status of the order is under negotiation. The buyer and the seller can click the finalized button (1220) to indicate the status of the order negotiation is finalized. If the status is under negotiation, the seller can click the negotiate button to further negotiate the order information. If the status is finalized, the seller can choose the accept button to accept the order or decline button to decline the order.

In the above example, the server can also communicate with the clients by providing the status, showing last updated features and feature tags, suggesting the next step, converting to international standards, automatically generating some information for the clients, enable attach files, providing help information, etc.

Email clients such as Microsoft Outlook can also be a client system. In this case, the email content can be formatted as required by the server. For example, using XML style tags in email content to specify features, tags, status, etc.

```
<order>
  <buyer>buyer</buyer>
  <seller>seller</seller>
  <status>negotiating</status>
  <product>
    <name>baseball caps</name>
    <feature> light blue color, pantone color 1234-534 </feature>
    <feature tags>color, blue color, light blue color</ feature tags>
  </product>
  <packaging>
  ...
  </packaging>
  <duedate>
  ....
  </duedate>
  <warranty>
    ...
  </warranty>
    <payment>
    ...
    </payment>
    <shipping>
    ...
      </shipping>
      <cost>
      ...
      </cost>
    ...
</order>
```

Alternately, the email content can use simple forms like the following.

### Order:

Buyer: buyer
Seller: seller
Status: negotiating
Product Name: baseball caps
Feature: light blue color, pantone color 1234-534
Feature Tags: color, blue color, light blue color
Feature: a feature
Feature Tags: feature tag, feature tag, . . . .
- - -

### Packaging Name:

- - -

The buyers can simply send their specification by email without complying with the specific format set by the server. The server is able to generate the order quality information automatically.

The following is an example application for the invention.

An importer goes to crossOrder.com to order custom baseball caps. crossOrder.com is an Internet marketplace for the products and services that are customizable and for international business. It implements the evaluation server shown in FIG. 1.

The importer enters query keywords “baseball caps, color (90, 70%), cotton” that are required in his specification where (90, 70%) is the requested quality rating of the color. (90, 70%) means there must be at least 90 reviews with an average quality rating of 70% or better. It can be simplified to like “baseball caps, color 70%, cotton” where 70% means average quality rating of color of 70% or better and more reviews will be ranked higher.

The evaluation server at crossOrder.com queries the data storage element of past reviews for suppliers. One of the search results is the following:

The cotton baseball caps

### Kinsky Limited Color (100, 80%), Design (200, 70%)

where the first line is the name of the product. The second line is the company name, Kinsky Limited, followed by the feature tags and their evaluation. The first number of the evaluation is the total number of past ratings of the feature tag. The second number of the evaluation is the average quality rating (on a 0-100% scale) of the feature tag. The feature tags are ordered to best match the search query.

If the importer clicks the product name, the new page shows technical details of the product, as follows.

### Technical Details:

Twill cotton baseball caps
Blue color with pantone code 24242-242
Lining with 100% silk

### Packaging:

Transparent plastic bag 10 cm×20 cm
White paper box 100 cm×200 cm
. . .

If the importer clicks the seller name, the new page shows the evaluations of feature tags and products of the seller.

### T-shirts (200, 80%)

### Color (100, 80%), Design (200, 90%), Logo (50, 80%), . . . .

If the importer clicks the feature tags such as “color”, the new page shows the list of products with the feature tag “color” and the feature tag evaluations.

Twill cotton baseball caps

### Kingsky Limited: Color (100, 50%)

Silk baseball caps

### Wang Headwear Limited: Color (50, 40%)

- - -

The importer selects a product from Twill cotton baseball caps from Kingsky Limited. However, the product does not completely match his needs. He reviews the technical details received by a web browser. The importer modifies the feature to “light blue color with pantone color 242-242”; its feature tag to “light blue color, blue color, color” where “light blue color”, “blue color”, “color” are three feature tags.

Then the importer clicks the “negotiate” button to get feedback from the manufacturer. The manufacturer reviews the order information from the buyer by a web browser. The manufacturer selects “accept” to accept the order. The agreement between the importer and manufacturer are recorded in crossOrder.com. The importer then pays the order as scheduled in the order agreement.

After producing the order based on the order agreement, the manufacturer gives ratings to feature tags and comments according to the order agreement.

After receiving the order, the importer reviews the order and provides ratings to feature tags and comments from the order agreement.

Upon receiving the order review information, the server generates the new review summary:

The rating of each feature is formatted as follows.

Feature: light blue color with pantone color 242-242
Feature tag: color

### Rating: 4

Comments: color is matched very well.
. . .

The server generates the order review summary as follows.

- - -
The overall rating of the order: (200, 80%):
The overall rating of feature tags of the seller: color (100, 80%)
The overall rating of the seller: (100, 70%)
- - -

The server updates and records the new evolution information. The updated evaluation information will be used for search engines to review and evaluate other orders.

It will be clear to one skilled in the art that the above embodiments may be altered in many ways without departing from the scope of the invention. Accordingly, the scope of the invention should be determined by the claims and their legal equivalents in this document.

What is claimed is:

1. A computer-implemented method for dynamically evaluating and searching for products and suppliers, the method comprises:
receiving from a first buyer an order evaluation about a first product of a supplier, the order evaluation including ratings of manufacturing features characterizing qualities of the supplier;
storing the order evaluation in a data storage element;
receiving from a second buyer a search query for suppliers of a second product, the search query including requirements of manufacturing features;
searching order evaluations in the data storage element for suppliers of the second product satisfying the requirements in the search query; and
responsive to the first product being similar to the second product and the ratings in the order evaluation satisfying the requirements in the search query, returning to the second buyer the supplier in a search result of the search query.

2. The method of claim 1, further comprising:
formatting the order evaluation with manufacturing feature tags, each manufacturing feature tag including a standardized keyword describing a manufacturing feature characterizing a quality of the supplier; and
formatting the requirements in the search query with corresponding manufacturing feature tags, wherein the searching comprises searching for order evaluations with ratings satisfying the requirements in the search query and associated with matching manufacturing feature tags.

3. The method of claim 2, wherein fulfilling an order for the first product or the second product requires the supplier to conduct a plurality of manufacturing processes, and wherein each manufacturing feature tag corresponds with one of the plurality of manufacturing processes of the first product and the second product and is associated with a rating.

4. The method of claim 1, wherein the first product is manufactured according to a specification provided by the first buyer.

5. The method of claim 1, further comprising:
receiving from the second buyer an order for the second product, the order specifying requirements of the second product.

6. The method of claim 5, further comprising:
formatting the order to include a set of manufacturing feature tags following by corresponding requirements and optionally comments.

7. The method of claim 1, further comprising:
facilitating an order negotiation between the second buyer and the supplier of the second product; and
generating an order for the second product based on finalized order information of the order negotiation.

8. The method of claim 7, further comprising:
generating order evaluation for the second buyer based on requirements in the order.

9. The method of claim 7, wherein the facilitating comprises enabling the second buyer and the supplier to edit, sign, or encrypt order information to generate the finalized order information.

10. The method of claim 7, further comprising:
generating an overall rating of the order, an overall rating of the seller, and an overall rating of the second buyer.

11. The method of claim 10, wherein the overall rating of the order is calculated by calculating the total number of ratings of all of the features or feature tag of the order, calculating the total ratings of all of the features or feature tag of the order, and calculating the percentage and/or average of ratings of all of the features or feature tag in the order.

12. The method of claim 1, further comprising:
consolidating the order evaluation with other order evaluations of the first product or the supplier to generate a review summary, wherein the searching comprises searching review summaries for suppliers satisfying the requirements in the search query.

13. The method of claim 1, further comprising:
receiving a review of the first buyer from the supplier, the review including ratings of features characterizing qualities of the first buyer.

14. The method of claim 13, further comprising:
enabling suppliers to search reviews for qualities of a specific buyer or buyers of a specific quality.

15. The method of claim 1, wherein the search query is in the format of feature tags followed by their requested quality rating or range of ratings, and wherein the search result is formatted at least in part as feature tags following by ratings and optional comments.

16. The method of claim 1 wherein the order evaluation includes comments.

17. The method of claim 1, wherein the first product includes a service and the supplier includes a service provider.

18. The method of claim 1, wherein the method is for a Business-to-Business computer system targeting suppliers and buyers from multiple countries.

19. A computer program product dynamically evaluating and searching for products and suppliers, the computer program product comprising a computer-readable medium containing computer program code for performing a method comprising:
receiving from a first buyer an order evaluation about a first product of a supplier, the order evaluation including ratings of manufacturing features characterizing qualities of the supplier;
storing the order evaluation in a data storage element;
receiving from a second buyer a search query for suppliers of a second product, the search query including requirements of manufacturing features;
searching order evaluations in the data storage element for suppliers of the second product satisfying the requirements in the search query; and
responsive to the first product being similar to the second product and the ratings in the order evaluation satisfying the requirements in the search query, returning to the second buyer the supplier in a search result of the search query.

20. A computer system for dynamically evaluating and searching for products and suppliers, the computer system comprises:
an evaluation server and client systems connected to one another via a computer based distributed network, the evaluation server comprising the following:
a means for receiving from a first buyer an order evaluation about a first product of a supplier, the order evaluation including ratings of manufacturing features characterizing qualities of the supplier;
a means for storing the order evaluation in a data storage element;
a means for receiving from a second buyer a search query for suppliers of a second product, the search query including requirements of manufacturing features;
a means for searching order evaluations in the data storage element for suppliers of the second product satisfying the requirements in the search query; and
a means for responsive to the first product being similar to the second product and the ratings in the order evaluation satisfying the requirements in the search query, returning to the second buyer the supplier in a search result of the search query.
